(19) United States
(12) Patent Application Publication
(10) Pub. No.: US 2010/0293167 A1
(43) Pub. Date: Nov. 18, 2010

(54) BIOLOGICAL DATABASE INDEX AND QUERY SEARCHING

(76) Inventors: Daniele Biasci, Pisa (IT); Guido Giudetti, Pisa (IT); Massimiliano Andreazzoli, Pisa (IT)

Correspondence Address: Daniele Biasci, Loc Botriolo 74, Casciana Terme Pisa, 56034, IT

(21) Appl. No.: 12/665,194

(22) PCT Filed: Jun. 18, 2008
(86) PCT No.: PCT/US08/07568

§ 371 Date: Dec. 17, 2009

Related U.S. Application Data
(60) Provisional application No. 60/929,230, filed on Jun. 18, 2007.

(51) Int. Cl. G06F 17/30

(52) U.S. Cl. 707/741; 707/769; 707/E17.014; 707/E17.002

(57) ABSTRACT

Methods and system for biological database indexing and query searching are described. In one embodiment, one or more words may be extracted from a biological sequence using a spacer. The spacer may be one or more characters within the biological sequence. The word and a position of the word within the biological sequence may be stored in a sequence index associated with the spacer. The sequence index may be capable of being used for an operation associated with the biological sequence.

### CROSS-REFERENCE TO A RELATED APPLICATION

This application claims the benefit of United States Provisional Patent Application entitled “METHOD AND SYSTEM FOR BIOLOGICAL DATABASE INDEXING AND SEARCH FOR PERFECT, NEAR PERFECT OR GAPPED ALIGNMENTS OF NUCLEOTIDE OR PEPTIDE SEQUENCES”, Ser. No. 60/929,230, filed 18 Jun. 2007, the entire contents of which are herein incorporated by reference.

### BACKGROUND

Genetic information is coded in long and continuous sequences of 4 bases (Adenine, Cytosine, Guanine, Thymine/Uracil) conventionally represented by four letters (A, C, G, T for DNA or A, C, G, U for RNA).

Primary protein structure is coded by continuous sequences of aminoacids, conventionally represented by three letter abbreviations and Latin alphabet letters (G, P, A, V, L, I, M, C, F, Y, W, H, K, R, Q, N, E, D, S, T).

Modern sequencing techniques allow the sequencing of entire genomes including, among others, man's genomes. Ever-growing biological databases grew to contain genomic and peptidic sequences from many different organisms.

Biological databases may be used as a tool (e.g., through sequence matching) to assist scientists to understand and explain a host of biological phenomena. This knowledge may help facilitate the fight against diseases, assists in the development of medications and in discovering basic relationships amongst species in the history of life.

Due to the developments in modern sequencing techniques and its ease of use, a large number of scientists regularly use huge biological databases to further their projects. Moreover, the advent of personal genomics may increase the raw quantity of sequencing data also in private databases and may further the desire for simple and fast access to biological databases and genome comparison tasks. For example, web-based search engines are frequently used to search entire genomes or transscriptomes. Currently, a popular biological search engine (such as biological search engines maintained by NCBI and EMBL) might execute over million searches per day on available biological data, which has a size in excess thousands of Gigabytes. Search queries on these databases request long times and results are often only approximate.

### BRIEF DESCRIPTION OF THE DRAWINGS

Some embodiments are illustrated by way of example and not limitation in the figures of the accompanying drawings in which:

FIG. 1 is a block diagram of a system, according to example embodiments;

FIG. 2 is a block diagram of an example query subsystem that may be deployed within the system of FIG. 1 according to an example embodiment;

FIG. 3 is a block diagram of an example indexing subsystem that may be deployed within the system of FIG. 1 according to an example embodiment;

FIGS. 4 and 5 are flowcharts illustrating a method for query processing according to an example embodiment;

FIG. 6 is a diagram of an example search diagram according to an example embodiment (SEQ ID NOs: 1-7);

FIG. 7 is a diagram of an example sequence index diagram according to an example embodiment (SEQ ID NO: 8);

FIG. 8 is a diagram of an example spacer application diagram according to an example embodiment (SEQ ID NOs: 9-12);

FIG. 9 is a flowchart illustrating a method for probe word access according to an example embodiment;

FIGS. 10-12 are flowcharts illustrating a method for sequence indexing according to an example embodiment;

FIG. 13 is a diagram of an example word extraction diagram according to an example embodiment (SEQ ID NOs: 13-17);

FIG. 14 is a diagram of an example database indexing diagram according to an example embodiment (SEQ ID NOs: 14-22);

FIGS. 15-17 are diagrams of example sequence indexing diagrams according to an example embodiment (SEQ ID NOs: 23-37);

FIG. 18 is a flowchart illustrating a method for word extraction according to an example embodiment;

FIGS. 19-22 are example diagrams according to an example embodiment;

FIG. 23 is an example table according to an example embodiment;

FIG. 24 is an example diagram according to an example embodiment;

FIG. 25 is an example table according to an example embodiment; and

FIG. 26 is a block diagram diagrammatic representation of machine in the example form of a computer system within which a set of instructions for causing the machine to perform any one or more of the methodologies discussed herein may be executed.

### DETAILED DESCRIPTION

Example methods and systems for biological database indexing and query searching are described. In the following description, for purposes of explanation, numerous specific details are set forth in order to provide a thorough understanding of example embodiments; It will be evident, however, to one skilled in the art that embodiments of the present invention may be practiced without these specific details.

In an example embodiment, a query for a source sequence may be received. One or more probe words of the source sequence may be accessed. A plurality of candidate sequences may be identified using a sequence index and the probe word. The plurality of candidate sequences may be accessed from a target sequence database. An operation may be performed on the plurality of candidate sequences using the query. An output may be provided based on the performing of the operation.

In an example embodiment, a word may be extracted from a biological sequence using a spacer. The spacer may be a particular character within the biological sequence. The word and a position of the word within the biological sequence may be stored in a sequence index associated with the spacer. The sequence index may be capable of being used for an operation associated with the biological sequence.

In an example embodiment, the methods and systems of the various embodiments may enable biological database indexing and searching for perfect, near perfect or gapped alignments of nucleotide or peptide sequences, or other biological data.

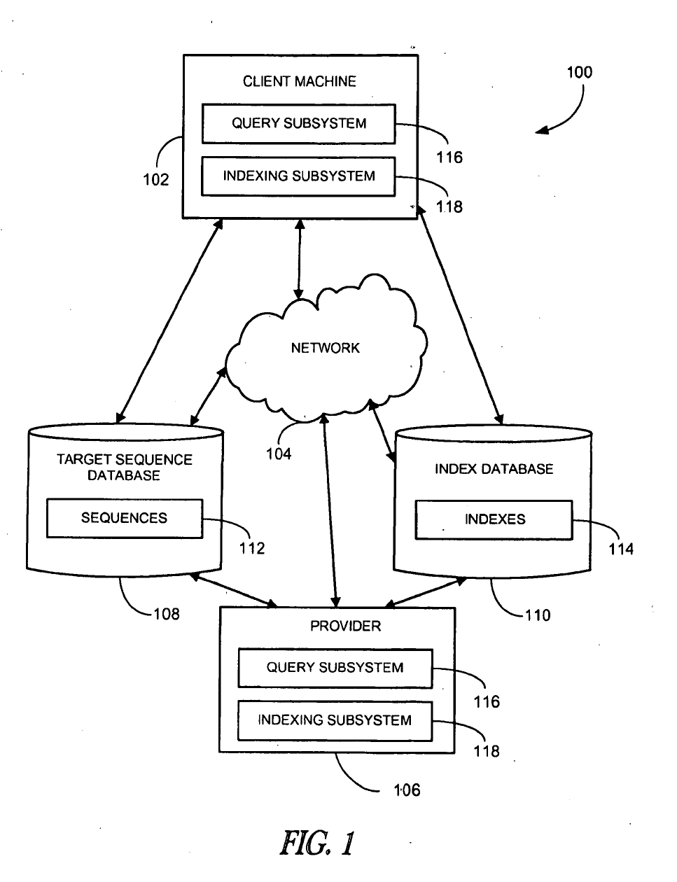

FIG. 1 illustrates an example system 100 in which a client machine 102 communicates with a provider 106 over a network 104. A user may communicate with a client machine 102 and/or a provider 106 to query a number of sequences 112 in a target sequence database 108. The query determines a full or partial sequence match of a probe with the sequences 112.

Examples of the client machine 102 include a set-top box (STB), a receiver card, a mobile telephone, a personal digital assistant (PDA), a display device, a portable gaming unit, and a computing system; however other devices may also be used.

The network 104 over which the client machine 102 and the provider 106 are in communication may include a Global System for Mobile Communications (GSM) network, an Internet Protocol (IP) network, a Wireless Application Protocol (WAP) network, a WiFi network, or a IEEE 802.11 standards network as well as various combinations thereof. Other conventional and/or later developed wired and wireless networks may also be used.

The client machine 102 and/or the provider 106 may include a query subsystem 116 and/or an indexing subsystem 118. The query subsystem 116 receives a query for a source sequence, accesses one of more probe words of the source sequence, identifies candidate sequences using one or more sequence indexes 114 and the probe words, accesses the candidate sequences 112 from the target sequence database 108, performs an operation on the candidate sequences using the query, and provides an output based on the performing of the operation.

The indexing subsystem 118 extracts one or more words from a biological sequence using one or more spacers and stores the word and a position of the word within the biological sequence in a sequence index associated with the spacer in the index database 110 as one of the indexes. The index may be in the form of a listing or may be implemented otherwise.

The use of the query subsystem 116 and/or the indexing subsystem 118 improves indexing speed, searching speed, obtains exact, non-approximate results as an output, and/or utilizes a low amount of RAM.

The client machine 102 and/or the provider 106 may be in communication with the target sequence database 108 and/or an index database 110. The target sequence database 108 and/or an index database 110 may be in a single combined database, distributed over a number of databases, or may be otherwise configured. The databases 108, 110 may be a relational database, a flat binary file database, or a different type of database. The databases 108, 110 may be SAP databases, MS-Access databases, Oracle databases, or a different kind of database.

Data in the databases 108, 110, in an example embodiment, may be defined, displayed, inserted, changed and/or deleted data by the use of structured query language (SQL). The databases 108, 110 may execute SQL statements within transactions. The SQL may be webSQL or a different type of SQL.

The indexes 114 are capable of being used for an operation associated with the sequences 112. A number of indexes 114 stored within the index database 110 contain the words extracted by the sequences 112. Each of the indexes 114 may be respectively associated with a particular spacer used to extract words from sequences. The words in the indexes 114 may be associated with a value indication of an original deviation sequence and/or a position in the original deviation sequence. Multiple indexes 114 may be used with the system 100. The indexes 114 may include words having variable length. The use of variable length words may increase the search speed.

The indexes 114 need not be rebuilt when the target sequence database 108 is updated. For example, if a new sequence is added to the target sequence database 108, the new sequence may be indexed and added to the indexes 114. If a particular sequence of the sequences 112 is removed from the target sequence database 108, the sequence is removed from the indexes 114 by deleting the occurrences of their related words. If a particular sequence of the sequences 112 is modified, the related words are removed from the indexes 114 and the particular sequence may be re-indexed.

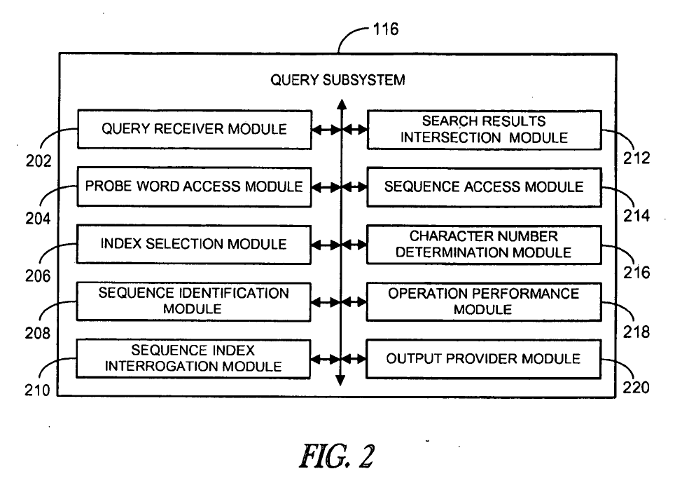

FIG. 2 illustrates an example query subsystem 200 that may be deployed in the client machine 102 and/or the provider 106 of the system 100 (see FIG. 1) or otherwise deployed in another system. The query subsystem 200 includes a query receiver module 202, a probe word access module 204, an index selection module 206, a sequence identification module 208, a sequence index interrogation module 210, a search results intersection module 212, a sequence access module 214, a character number determination module 216, an operation performance module 218, and/or an output provider module 220. Other modules' may also be included.

The query receiver module 202 receives a query for a source sequence. The probe word access module 204 accesses one or more probes word of the source sequence. The index selection module 206 selects one or more sequence indexes from available sequence indexes 114 based on the probe words.

The sequence identification module 208 identifies candidate sequences using a sequence index and the probe words. The identification of the candidate sequences includes obtaining a list of identifiers for the candidate sequences. An identifier can be a number, alphanumeric, or other symbol uniquely representing a sequence.

The sequence index interrogation module 210 interrogates an additional sequence index using the query to identify additional candidate sequences. The search results intersection module 212 intersects the candidate sequences and the additional candidate sequences to identify intersected candidate sequences (e.g., shared candidate sequences in both the candidate sequences and the additional candidate sequences). The candidate sequences, the additional, and/or the intersected candidate sequences may be in a list or otherwise retained, for example, stored memory.

The sequence access module 214 accesses the candidate sequences or intersected candidate sequences from a target sequence database. The access of the candidate sequences or intersected candidate sequences may be based on a list of identifiers. The character number determination module 216 determines a total character number of the probe word.

The operation performance module 218 performs an operation on the candidate sequences using the query. The operation may be a search, a comparison, or the like. The performance of the operation may be based on the total character number (e.g., a total number of the characters). The output provider module 220 provides an output based on performance of the operation.

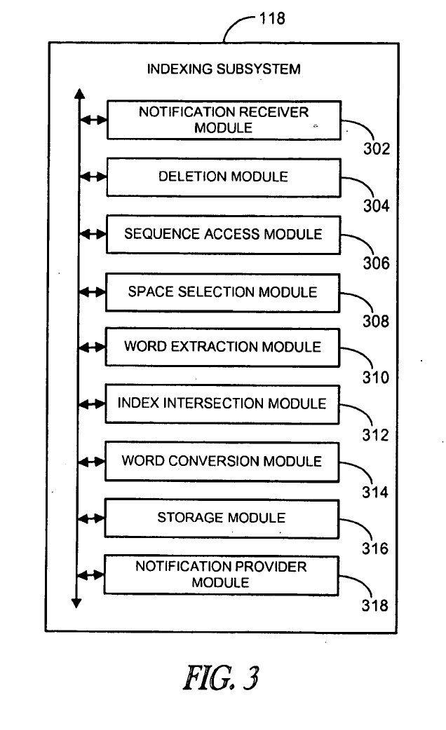

FIG. 3 illustrates an example indexing subsystem 300 that may be deployed in the client machine 102 and/or the provider 106 of the system 100 (see FIG. 1) or otherwise deployed in another system. The indexing subsystem 300 includes a notification receiver module 302, a deletion module 304, a sequence access module 306, a spacer selection module 308, a word extraction module 310, an index intersection module 312, a word conversion module 314, a storage module 316, and/or a notification provider module 318. Other modules may also be included.

The notification receiver module 302 receives a deletion notification of a deletion of the biological sequence from the target sequence database 108, receives an addition notification of an addition of the biological sequence, and/or receives a modification notification of a prior biological sequence.

The deletion module 304 deletes the position of the word within the biological sequence based on the receiving of the deletion notification and/or deletes a prior position of a prior word within the prior biological sequence based on the receiving of the modification notification.

The sequence access module 306 accesses the biological sequence from the target sequence database 108. The spacer selection module 308 receives a selection of the spacer from a spacer set or selects the spacer from a spacer set.

The word extraction module 310 extracts one or more words from a biological sequence using a spacer and/or one or more additional words from the biological sequence using an additional spacer. The spacer may be a particular character within the biological sequence between which a sequence of non-spacer characters define a word. The additional spacer may be a different character within the biological sequence than the particular character. The extraction of the word from the biological sequence using the spacer may be based on receipt of the addition notification and/or the modification notification.

This word extraction module 310 may be used in iterations until a word-length based score or other type of score is reached. The use may reduce a number of candidate sequences to forward to further modules.

The index intersection module 312 intersects a result of reading the sequence identifiers and the additional sequence identifiers to create an intersected sequence index. The use of an intersected sequence index created by the index intersection module 312 may improve compression and search speed. The word conversion module 314 converts the word into an integer representation. Computerized queries using an integer may result in improved search speed.

The storage module 316 stores the word, an integer representing the word, a position of the word within the biological sequence in a sequence index associated with the spacer, and/or an identifier for the biological sequence in the sequence index. The storage module 316 may store an additional word and/or the position of the additional word within the biological sequence in the sequence index associated with the additional spacer.

The notification provider module 318 provides a sequence index generation notice based on the storing of the word and the position of the word.

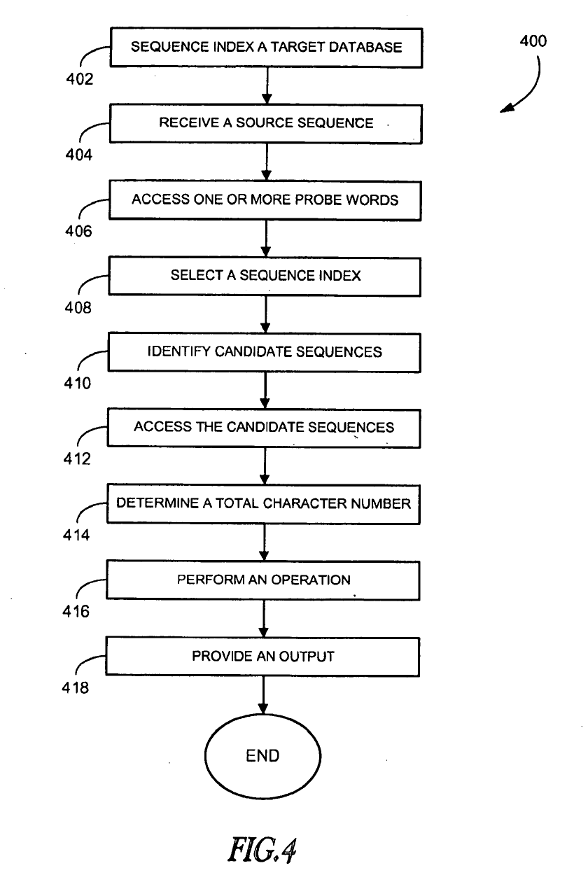

FIG. 4 illustrates a method 400 for query processing according to an example embodiment. The method 400 may be performed by the client machine 102 and/or the provider 106 of the system 100 (see FIG. 1) or otherwise performed.

The target sequence database 108 is sequence indexed using a spacer to create the sequence index at block 402. A query for a source sequence is received (e.g., from a user) at block 404.

One or more probe words of the source sequence are accessed at block 406. For example, the best available probe words of the source sequence may be accessed. A single probe word or multiple probe words (e.g., two probe words or more than two probe words) may be accessed. At block 408, the sequence index may be selected from available sequence indexes 114 based on the probe word.

Candidate sequences are identified using the sequence indexes and the probe words at block 410. The identification of the candidate sequences may include obtaining a list of identifiers for the candidate sequences. The identification may be made regardless sequence boundaries and without relying sequences being aligned along segment boundaries.

In an example embodiment, the candidate sequences may be further filtered (e.g., using a Boyer-Moore algorithm, BLAST; or Smith-Waterman algorithrn) during the operations at block 410. The type of filter used may be dependant on requested alignments.

The candidate sequences are accessed from a target sequence database at block 412. The candidate sequences may be accessed from the target sequence database 108 based on a list of identifiers or may be otherwise accessed: A total character number that includes a count of the number of the characters of the probe word may be determined at block 414.

An operation is performed on the candidate sequences using the query at block 416. The operation includes, by way of example, a search or a comparison. For example, a perfect match searching to determine all the sequences that entirely and exactly contain a probe sequence P may be performed. The perfect match searches may be used, by way of an example, in a probe-set reannotation for microarray experiments, a PCR primer validation, with a SNP (single-nucleotide polymorphisms), or the like. The operations may include identifying one or more words in the index with defined similarity with the probe words.

Other operations that may be performed include microarray probe annotation update, microarray oligo probe design, probe design for high-throughput technologies and applications, whole genome gene search, whole genome SNP search, EST/genomic contig generation, sequence comparison, whole genome-to-genome comparison (between equal/different species or individuals), sequence retrieval, evolutionary conservation studies, transcript-to-genome mapping, SNP-to-genome mapping, whole genome gene search, sequence-to-genome mapping, sequence retrieval (batch mode allowed), genome resequencing, whole genome PCR primer validation, gene discovery, alone or in combination to other alignment algorithms, MicroRNA mature and precursor sequences' genome or transcriptome mapping, peptidic sequence search and comparison, MALDI-TOF peptide annotation and identification. In an example embodiment, natural words (breaking frame free) extracted by the method 400 may be used to generate a fingerprint for biological sequences so that sequences with similar fingerprint can be clustered. Sequence clustering based on their “words fingerprint” may be used to remove redundancies from and reorder/cleanup large biological databases. Other operations may also be performed.

In an example embodiment, a perfect match search, a near-perfect search and/or a gapped match search can be performed by varying the stringency criterion in the sequence index selection and in candidate sequence identification.

In an example embodiment, the operation may include identification of a particular candidate sequence among the candidate sequences using the query. For example, the operation may include identification a particular sequence of the plurality of candidate sequences that includes the probe word and/or an additional probe word. The performance of the operation may be based on the total character number.

An output is provided based on performance of the operation at block 418. The output may include, by way of example, a single candidate sequence or multiple candidate sequences. For example, one or more candidate sequences may be forwarded to a BLAST algorithm, to a rigorous sequence alignment algorithm (e.g., Smith-Waterman algorithm), or otherwise forwarded for further processing.

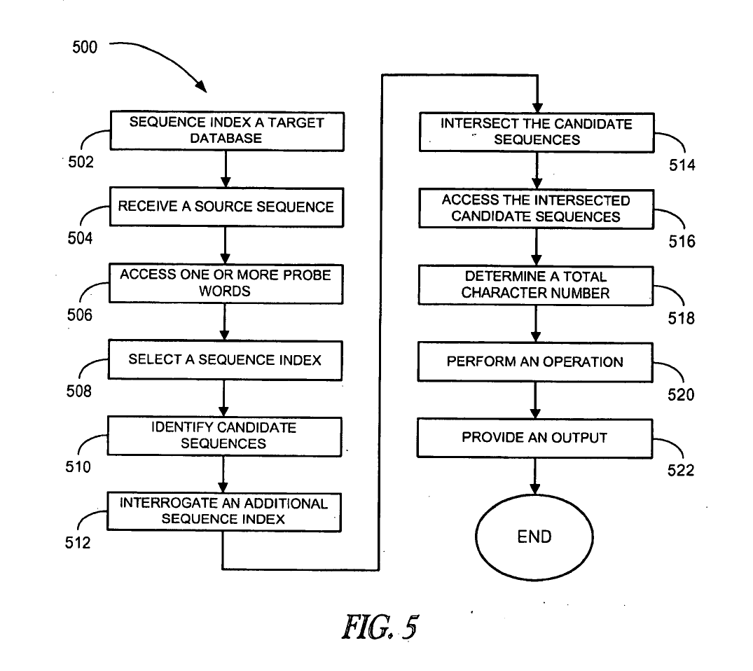

FIG. 5 illustrates a method 500 for query processing according town example embodiment. The method 500 may be performed by the client machine 102 and/or the provider 106 of the system 100 (see FIG. 1) or otherwise performed.

The target sequence database is sequence indexed using a spacer to create the sequence index at block 502. A query for a source sequence is received (e.g., from a user) at block 504.

One or more probe words of the source sequence is accessed at block 506. At block 508, the sequence index is selected from the available sequence indexes 114 based on the probe words.

Candidate sequences are identified using the sequence indexes and the probe words at block 510. The identification of the candidate sequences may include obtaining a list of identifiers for the candidate sequences. At block 512, one or more additional sequence indexes is interrogated using the query to identify additional candidate sequences.

The candidate sequences and the additional candidate sequences intersect to identify intersected candidate sequences at block 514. The use of intersected candidate sequences may reduce a number of candidate sequences and/or improve the speed of searches.

The intersected candidate sequences are accessed from a target sequence database at block 516. The intersected candidate sequences may be accessed from the target sequence database 108 based on a list of identifiers or may be otherwise accessed. A total character number of the probe word may be determined at block 518.

An operation is performed on the intersected candidate sequences using the query at block 520. The performance of the operation may be based on the total character number.

In an example embodiment, the operations may be a perfect match search. Only the common sequences across the various lists may be considered as acceptable candidates. As the exact position of each word into each sequence is known, only those sequences in which selected words occur in the same relative position as in the probe “P” may be sorted out. The result is a small number of candidate sequences, containing P in an exact manner with a high probability. Using less stringent selection criterion (e.g., considering as acceptable candidates all the sequences that are present at least in ⅔ of the lists), it is possible to obtain a list of candidate sequences for only partially containing P (e.g., a near perfect match). It is possible to consider as valid candidates only the sequences that contain only parts of P, at a given relative distance in respect to their position in P (e.g., a gapped match).

An output is provided based on performance of the operation at block 522. The output may include, by way of example, a single candidate sequence or multiple candidate sequences. The output can be stored in memory or displayed to the user electronically or in a hard copy.

In an example embodiment, the methods 400, 500 may be used to determine whether one or more probe words are someway contained in a particular sequence in any position. If the probe words are contained in the sequence, then the set of words extracted from the source sequence will be a subset of the words extracted from a target sequence. If the target sequence does not exactly contain each and every word extracted from one or more the source sequence, then the target sequence does not contain exactly the source sequence.

In an example embodiment, the methods 400, 500 are used to extracting the words contained in a probe and using them to search the indexes and find the sequences that probably contain the probe and define exactly which sequences certainly do not contain the probe.

In an example embodiment, the actual search defined by the query for the methods 400, 500 may then be carried on at a minimal fraction of the initial database. The use of the methods 400, 500 may bring a better performance in terms of search speed and computational power usage.

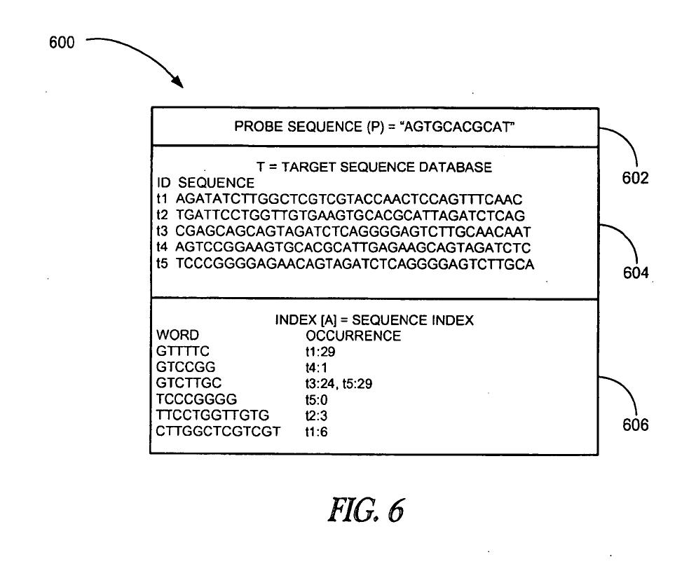

FIG. 6 is an illustration of an example search diagram 600 according to an example embodiment. The search diagram 600 reflects an example result of One or more operations of the methods 400, 500. However, other types of diagrams and/or different types of examples may reflect the result of the one or more operations of the methods 400, 500.

The probe sequence 602 for a target sequence database 604 is AGTGCACGCAT (SEQ ID NO: 38). One or more sequence indexes 606 for the target sequence database 604 are generated. The sequence index A may then include the following words:

| WORD | OCCURRENCE |
|---|---|
| GTTTTC | t1: 29 |
| GTCCGG | t4: 1 |
| GTCTTGC | t3: 24, t5: 29 |
| TCCCGGGG | t5: 0 |
| TTCCTGGTTGTG | t2: 3 (SEQ ID NO: 39) |
| CTTGGCTCGTCGT | tl: 6 (SEQ ID NO: 40) |

Other sequence indexes (e.g., sequence index C, sequence index G, and sequence index T) may include different words and have different occurrences.

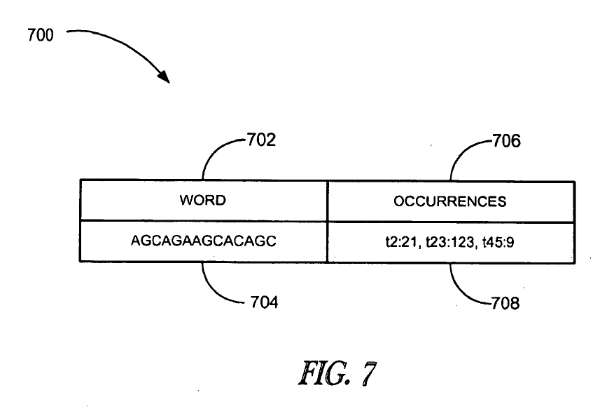

FIG. 7 is an illustration of an example sequence index diagram 700 according to an example embodiment. The sequence index diagram 700 reflects an example sequence index using during operations of the methods 400, 500. However, other types of diagrams and/or different types of examples may reflect the sequence index during the operations of the methods 400, 500.

The sequence index diagram 700 includes a word column 702 and an occurrences column 706. The word column 702 includes one or more word entries. The occurrences column 706 includes one or more occurrence entries that correspond to the one or more word entries. For example, the entry associated with a word entry 704 is “AGCAGAAGCACAGC” (SEQ ID NO: 41) and the occurrences associated with an occurrence entry 708 is “t2:21, t23:123, t45:9”.

The entries of the occurrences column 706 may be in a text string format, a binary format, or a different format to allow for the retrieval of the information about a single word in the index.

The sequence index diagram 700 reflects that the word entry 706 is contained in sequence t2 in position 21, in sequence t23 in position 123, and in sequence t45 in position 9.

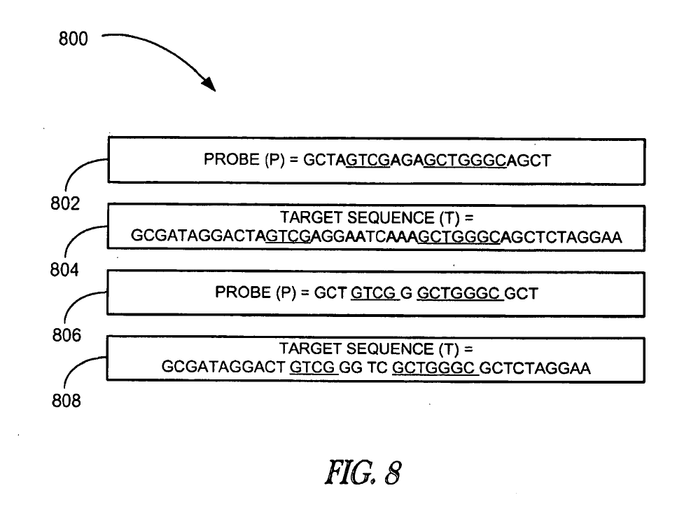

FIG. 8 is an illustration of an example spacer application diagram 800 according to an example embodiment. The spacer application diagram 800 reflects operations of the methods 400, 500. However, other types of diagrams and/or different types of examples may reflect the operations of the methods 400, 500.

In the spacer application diagram 800, a probe 802 is GCTAGTCGAGAGCTGGGCAGCT (SEQ ID NO: 42). A target sequence 802 is GCGATAGGACTAGTCGAGGAATCAAAGCTGGGCAGCTCTAGGAA (SEQ ID NO: 43).

Using a spacer A, a probe 806 is obtained as GCT GTCG G GCTGGGC GCT (SEQ ID NO: 44) and a target sequence 804 is obtained as t1=GCGATAGGACT GTCG GG TC GCTGGGC GCTCTAGGAA (SEQ ID NO: 45).

The probes 802, 806 are shown to contain the word GTCG in position 4 and word GCTGGGC in position 11. The relative distance of the two words is: 11−4−4=3. The target sequences 804, 808 are shown to contain the words GTCG and GCTGGGC, in position 13 and 27, respectively and their relative distance is 27−13−4=10. The difference between the two words' relative distances is gap (GTCG, GCTGGGC)=10−3=7

The probe 806 is partially overlappable to the target sequence 808, given that a T base gap is introduced between the common parts. The probe 806 and the target sequence 808 may be aligned when the gap values do not exceed a user defined value (e.g., a max_gap_score). If the value equals zero, the output provided during the operations at blocks 418, 522 is limited to only perfect match alignments. If the user defined value is greater than zero, partial alignments may also be elaborated during the operations at block 412 and provided during the operations at blocks 418, 522.

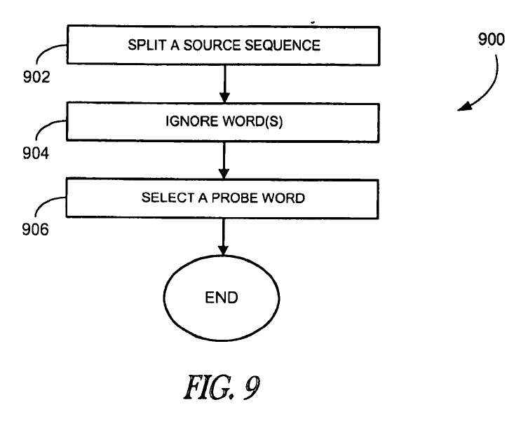

FIG. 9 illustrates a method 900 for probe word access according to an example embodiment. The method 900 may be performed at block 406, block 506, or otherwise performed.

The source sequence is split into available probe words using a spacer at block 902. The spacer may be a particular character within the source sequence.

An initial available probe word and/or a final available probe word of the available probe words may be ignored at block 904. The operations performed at block 904 may enable avoidance of extracting partial words from the probe sequences (e.g., words that are truncated at the extremes of the probe sequence) that could introduce a bias in the subsequent analysis.

By way of example, words have thus to be delimited by two spacers and not by one, as it happens to the sequence extremes:

| | |
|---|---|
| P = CGTGACTCGTGCGGCATTCCG | (SEQ ID NO: 46) |
| (spacer = ‘A’) | |
| P = CGTG CTCGTGCGGC TTCCG | (SEQ ID NO: 47) |

The sequence extremes in the example may be delimited by one spacer. These extremes may be discarded as not being a valid word for the sequence. The central part in P, delimited by two spacers “A” may instead be selected as a valid word and may be used.

The probe word is selected from the available probe words at block 906. The selection of the probe word may be based on a length of the probe word, based on the ignoring of the initial available probe word and/or the final available probe word, on statistical probability of word concurrency in the target sequence database 108 (e.g., where less frequent words may be desired), or may be otherwise selected.

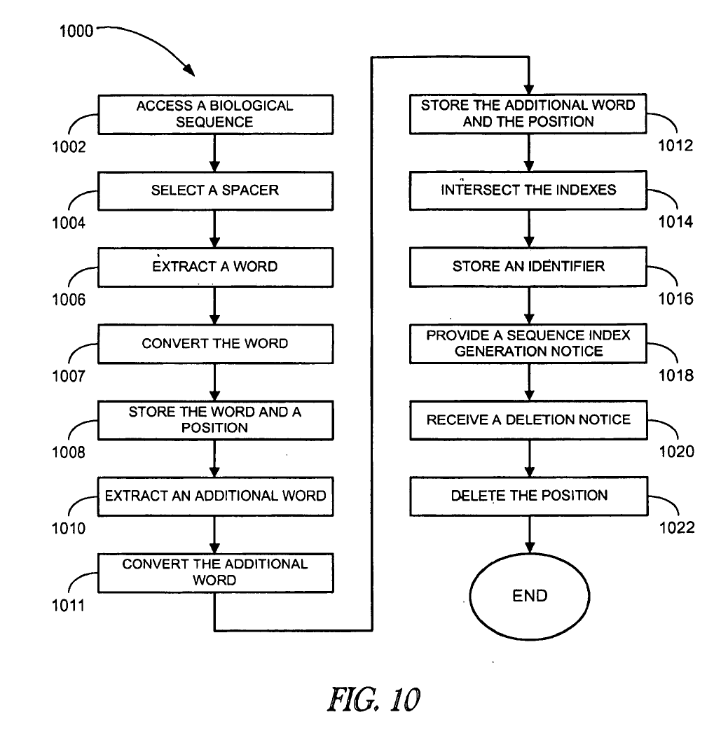

FIG. 10 illustrates a method 1000 for sequence indexing according to an example embodiment. The method 1000 may be performed by the client machine 102 and/or the provider 106 of the system 100 (see FIG. 1) or otherwise performed.

The biological sequence is accessed from the target sequence database 108 at block 1002. The biological sequence may be a genomic sequence, a cDNA sequence, a RNA sequence, an expressed sequence tag (EST) sequence, a peptidic sequence, or the like. The biological sequence may be a long, continuous sequence. Other types of biological sequences may also be accessed.

A spacer is selected from a spacer set at block 1004. The selection of the spacer may be made automatic, based on the receiving of a selection of the spacer (e.g., from a user), or may be otherwise selected.

The spacer may be one or more characters within the biological sequence. The spacer set may include, by way, of example, alphabetic symbols for a statistically relevant class of amino acids or nucleic acids, alphabetic symbols for a definite class of amino acids or nucleic acids, alphabetic symbols for DNA or RNA nucleotides, or the like. For example, the spacer set may be A, C, G, and/or T; A, C, G, and/or U; or G, P, A, V, L, I, M, C, F, Y, W, H, K, R, Q, N, E, D, S, and/or T. Other spacer sets may also be used. The spacer may be a single character or multiple characters.

One or more words are extracted from a biological sequence using a spacer at block 1006. In an example embodiment, the character spacer in the biological sequence may be substituted (e.g., for a blank character).

In an example embodiment, the spacer may be used to break the biological sequence into discrete fragments of variable length. The use of the spacer may enable extraction of natural words from the biological sequence. The use of the spacer may enable avoidance of considering multiple alignment frames between query and target sequence.

In an example embodiment, the use of the spacer enables avoidance of generating an index of biological sequences using ‘pseudo-words’. Some algorithms index biological sequences effectively segment each sequence in ‘pseudo-words’ by moving the sliding window several characters at a time. Thus, the method 1000 may not rely on query and target sequences being aligned along segment boundaries. For example, this alignment assumption may not generally be valid (e.g., when a query is made into a EST or transcriptome databases).

The word may be converted into an integer at block 1007. In an example embodiment, the conversion may include assigning a value to each letter of the word, converting the value into a base 10 number, and storing the converted number. The word AGAAAGGCCGC (SEQ ID NO: 48) may be stored without conversion by using a single byte for each character.

The conversion performed during the operations at block 1007 may include replacing a letter representing specific biological data with a number based on a spacer selection (e.g., replacement of the letter A with number 1, letter C with number 2 and letter G with number 3). Other example selections for the conversion may include:

If character chosen as spacer is A, then replacement rules are C=1, G=2, T=3;

If character chosen as spacer is C, then replacement rules are A=1, C=2, G=3;

If character chosen as spacer is G, then replacement rules are A=1, C=2, T=3; and

If character chosen as spacer is T, then replacement rules are A=1, C=2, G=3.

The selection of the character spacer results in an integer number of 13111332232 in base 4. The number may be converted into base 10 resulting in a number of 1925038. The integer number may be stored as long integer unsigned number using 4 bytes or may be otherwise stored. Word to integer conversion may be used as hash function on index building.

At block 1008, the word and a position of the word within the biological sequence is stored in a sequence index associated with the spacer. The sequence index may be capable of being used for an operation associated with the biological sequence. The word may be stored directly and/or an integer representing the word may be stored during the operations at block 1008. The word and the position may be stored within an array of the index database 110 or may be otherwise stored. In an example embodiment, a different index may be created for every element of the spacer set.

One or more additional words may be extracted from the biological sequence using an additional spacer at block 1010. The additional spacer may be different character within the biological sequence than the particular character. The additional word may be converted into an integer at block 1011.

At block 1012, the additional word and the position of the additional Word within the biological sequence may be stored in an additional sequence index associated with the additional spacer. The length of the word may be the same or a different length as the length of the additional word. The additional word may be stored directly and/or an integer representing the word may be stored during the operations at block 1012.

A result of reading the sequence index and the additional sequence index may be used to create an intersected sequence index at block 1014. An identifier for the biological sequence may be stored in the sequence index 114 (e.g., in the index database 110) at block 1016.

A sequence index generation notice may be provided based on the storing of the word and the position of the word at block 1018.

A deletion notification of a deletion of the biological sequence from the target sequence database 108 may be received at block 1020. The position of the word within the biological sequence may be deleted based on receipt of the deletion notification at block 1022.

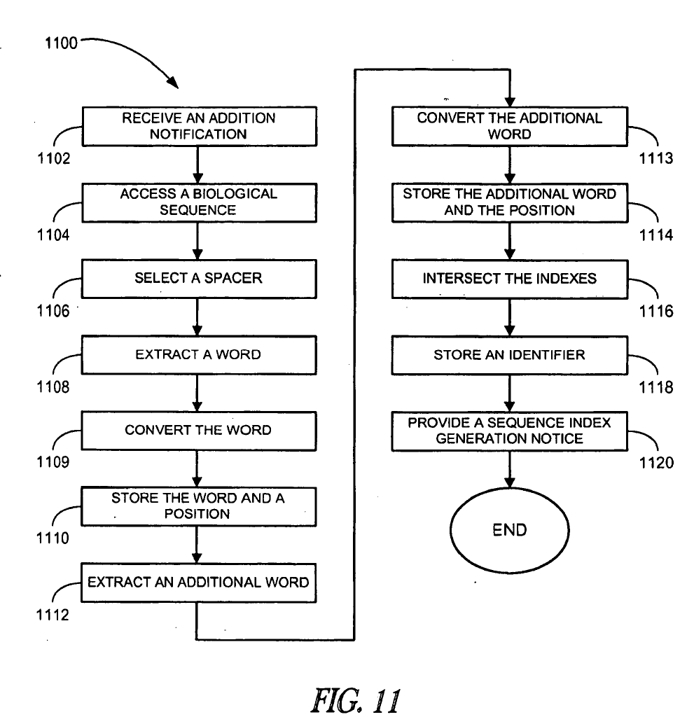

FIG. 11 illustrates a method 1100 for sequence indexing according to an example embodiment. The method 1100 may be performed by the client machine 102 and/or the provider 106 of the system 100 (see FIG. 1) or otherwise performed.

An addition notification of an addition of a biological sequence may be received at block 1102. The biological sequence may be accessed from the target sequence database 108 at block 1104.

A spacer may be selected from a spacer set at block 1106. The selection of the spacer may be made automatically, based on the receiving of a selection of the spacer (e.g., from a user), or may be otherwise selected.

One or more words are extracted from a biological sequence using a spacer at block 1108. The word may be converted into an integer at block 1109.

At block 1110, the word and a position of the word within the biological sequence is stored in a sequence index associated with the spacer. The word may be stored directly and/or an integer representing the word may be stored during the operations at block 1110.

An additional word may be extracted from the biological sequence using an additional spacer at block 1112. The additional spacer may be a different character within the biological sequence than the particular character. The additional word may be converted into an integer at block 1113.

At block 1114, the additional word and the position of the additional word within the biological sequence may be stored in an additional sequence index associated with the additional spacer. The length of the word may be the same or a different length as the length of the additional word. The additional word may be stored directly and/or an integer representing the word may be stored during the operations at block 1114.

A result of reading the sequence index and the additional sequence index may be used to create an intersected sequence index at block 1116. An identifier for the biological sequence may be stored in the sequence index at block 1118.

A sequence index generation notice may be provided based on storage of the word and the position of the word at block 1120.

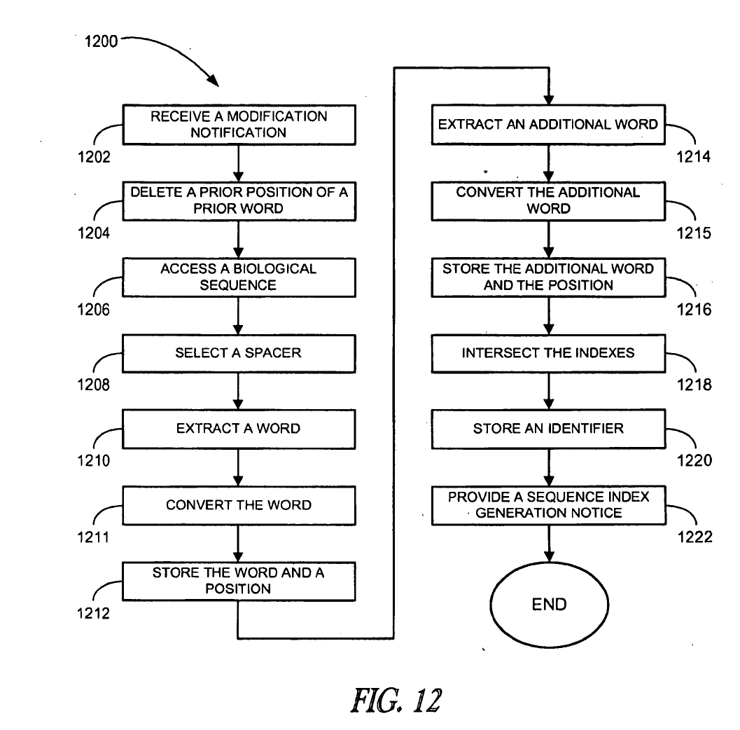

FIG. 12 illustrates a method 1200 for sequence indexing according to an example embodiment. The method 1200 may be performed by the client machine 102 and/or the provider 106 of the system 100 (see FIG. 1) or otherwise' performed.

A modification notification of a prior biological sequence may be received at block 1202. A prior position of a prior word within the prior biological sequence may be deleted based on receipt of the modification notification at block 1204.

The biological sequence may be accessed from a target sequence database at block 1206. A spacer may be selected from a spacer set at block 1208. The selection of the spacer may be made automatically, based on the receiving of a selection of the spacer (e.g., from a user), or may be otherwise selected.

One or more words are extracted from a biological sequence using a spacer at block 1210. The extraction of the word from the biological sequence using the spacer may be based on receipt of the modification notification. The word may be converted into an integer at block 1211.

At block 1212, the word and a position of the word within the biological sequence is stored in a sequence index associated with the spacer. The sequence index may be capable of being used for an operation associated with the biological sequence. The word may be stored directly and/or an integer representing the word may be stored during the operations at block 1212.

One or more additional words may be extracted from the biological sequence using an additional spacer at block 1214. The additional spacer may be a different character within the biological sequence than the particular character. The additional word may be converted into an integer at block 1215.

At block 1216, the additional word and the position of the additional word within the biological sequence may be stored in an additional sequence index associated with the additional spacer. The length of the word may be the same or a different length as the length of the additional word. The additional word may be stored directly and/or an integer representing the word play be stored during the operations at block 1216.

A result of reading the sequence index and the additional sequence index may be used to create an intersected sequence index at block 1218. An identifier for the biological sequence may be stored in the sequence index at block 1220.

A sequence index generation notice may be provided based on the storing of the word and the position of the word at block 1222.

In an example embodiment, the methods 1000, 1100, 1200 may be performed multiple times using different spacers to create multiple indexes.

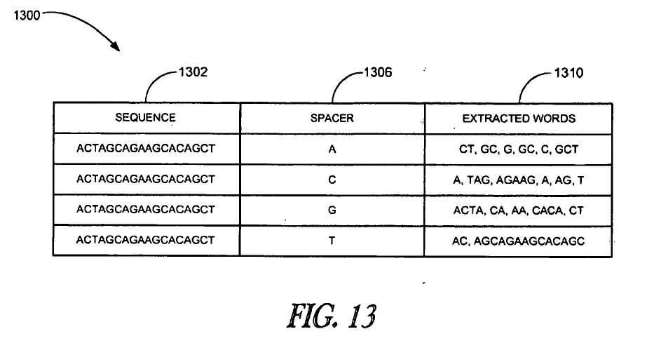

FIG. 13 illustrates an example word extraction diagram 1300 according to an example embodiment. The word extraction diagram 1300 reflects the extraction of one or more words during the operations at blocks 1108, 1112, 1210, 1214 of the methods 1100, 1200. However, other types of diagrams and/or different types of examples may reflect the operations during the methods 1100, 1200.

The word extraction diagram 1300 reflects the results of a word extraction using a four-letter spacer set S=[A, C, G, T] on the sequence

| | |
|---|---|
| “ACTAGCAGAAGCACAGCT”. | (SEQ ID NO: 49) |

Spacer T extracts quite a long word from the given sequence. By interrogating the index T, a list of candidate sequences containing word “AGCAGAAGCACAGC” is generated.

If only index_A is used, a list of candidate sequences containing word “GCT” (e.g., the longest word among those extracted using the spacer A) is generated. As the triplet “GCT” is statistically more frequent than “AGCAGAAGCACAGC” (SEQ ID NO: 50) on a whole genomic database, the candidate list is much bigger than using spacer T, thus involving a longer computation and search time.

In an example embodiment, a higher probability of extracting long and significant words from the probe may occur when more word extraction criterion is used to generate words from a sequence.

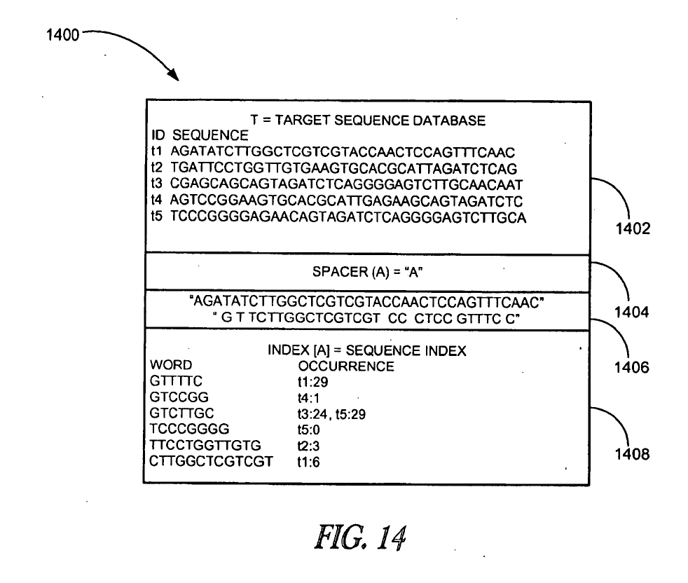

FIG. 14 illustrates an example database indexing diagram 1400 according to an example embodiment. The database indexing diagram 1400 may reflect the indexing performed during of the methods 1100, 1200. However, other types of diagrams and/or different types of examples may reflect the operations during the methods 1100, 1200.

A target sequence database 1402 is sequence indexed using a spacer 1404. The spacer may be a single character spacer of an available spacers set.

One or more sequences are extracted from the target sequence database 1402, and one or more words are extracted from the sequences as shown in a comparison 1406. The extracted words and their position of the analyzed sequence and/or an identifier for the analyzed sequence itself are stored into a sequence index 1408.

In an example embodiment, the operations performed during the methods 1100, 1200 may be iterated as desired. For example, different spacers may be used during the iterations to create multiple indexes.

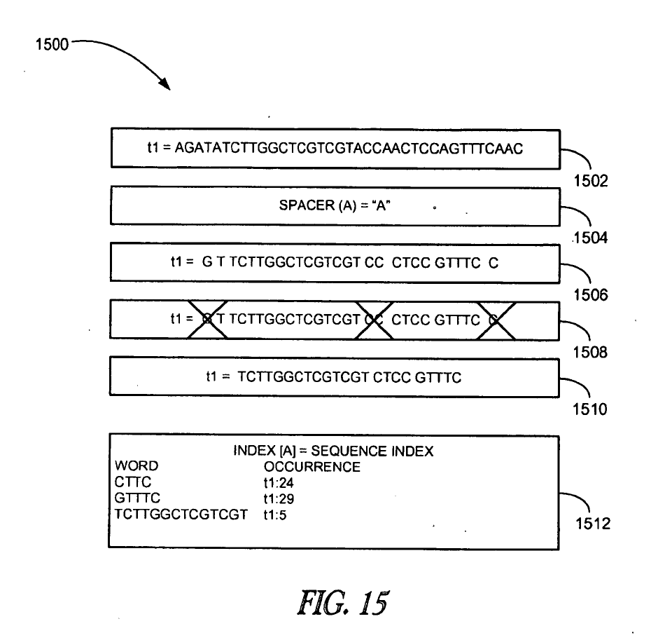

FIG. 15 illustrates an example sequence indexing diagram 1500 according to an example embodiment. The sequence indexing diagram 1500 reflects a single sequence indexing using a single character spacer performed during the methods 1100, 1200. However, other types of diagrams and/or different types of examples may reflect the operations during the methods 1100, 1200.

A single sequence 1502

(SEQ ID NO: 51)
“AGATATCTTGGCTCGTCGTACCAACTCCAGTTTCAAC”

is read from the target sequence database 108. A spacer 1504 of “A” is defined. A spacer application 1506 illustrates the replacement of the character of the spacer 1504 with a blank space character, a nonoccurring character, or a different character.

Elimination 1508 illustrates the elimination of insignificant and/or other short words from the spacer application 1506. A word extraction 1510 may illustrate the words from the single sequence 1502 after the spacer 1504 has been used. An index recordation 1512 may illustrate the occurrences of the words identified during the word extraction.

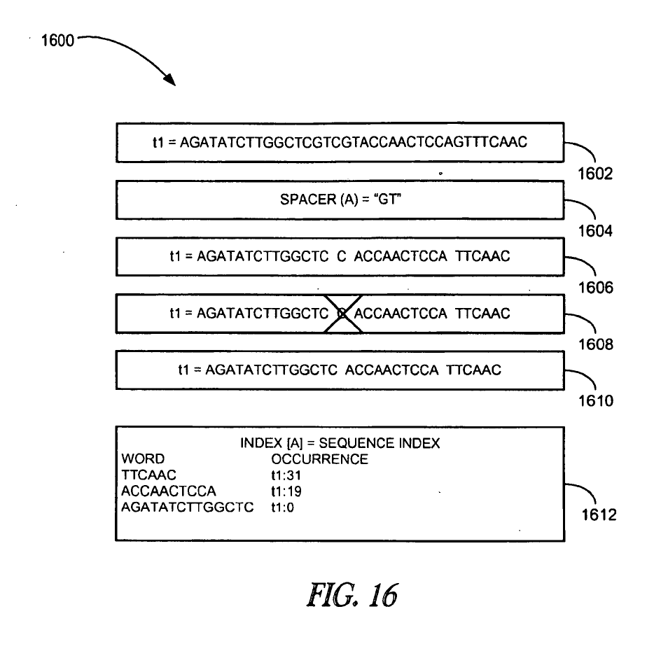

FIG. 16 illustrates an example sequence indexing diagram 1600 according to an example embodiment. The sequence indexing diagram 1600 reflects a single sequence indexing using a multiple character spacer performed during the indexing performed during of the methods 1100, 1200. However, other types of diagrams and/or different types of examples may reflect the operations during the methods 1100, 1200.

A single sequence 1602

(SEQ ID NO: 52)
“AGATATCTTGGCTCGTCGTACCAACTCCAGTTTCAAC”

read from the target sequence database 108. A spacer 1604 of “GT” is defined: A spacer application 1606 illustrates the replacement of the character of the spacer 1604 with a blank space character, a nonoccurring character, or a different character.

Elimination 1608 illustrates the elimination of insignificant and/or other short words from the spacer application 1606. A word extraction 1610 illustrates the words from the single sequence 1602 after the spacer 1604 has been used. An index recordation 1612 illustrates the occurrences of the words identified during the word extraction.

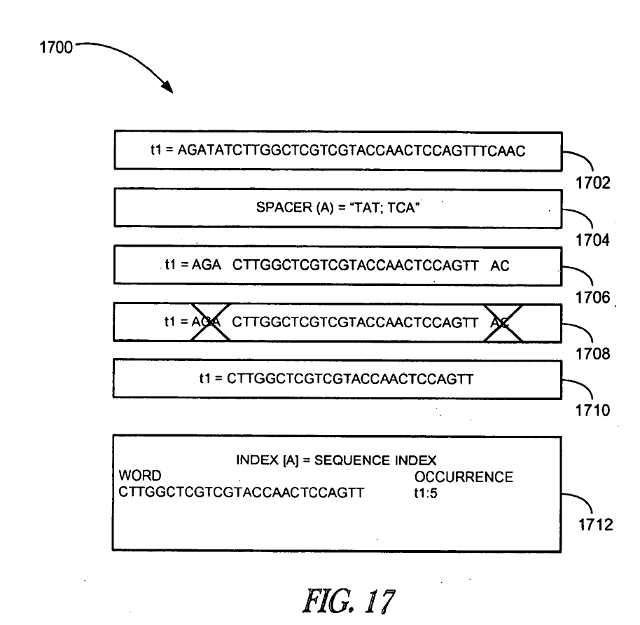

FIG. 17 illustrates an example sequence indexing diagram 1700 according to an example embodiment. The sequence indexing diagram 1700 reflects a single sequence indexing using more than one multiple character spacers during the indexing performed during of the methods 1100, 1200. However, other types of diagrams and/or different types of examples may reflect the operations during the methods 1100, 1200.

A single sequence 1702

(SEQ ID NO: 52)
“AGATATCTTGGCTCGTCGTACCAACTCCAGTTTCAAC”

read from the target sequence database 108. A spacer 1704 of “TAT; TCA” is defined. A spacer application 1706 illustrates the replacement of the character of the spacer 1704 with a blank space character, a nonoccurring character, or a different character.

Elimination 1708 illustrates the elimination of insignificant and/or other short words from the spacer application 1706. A word extraction 1710 illustrates the words from the single sequence 1702 after the spacer 1704 has been used. An index recordation 1712 illustrates the occurrences of the words identified during the word extraction.

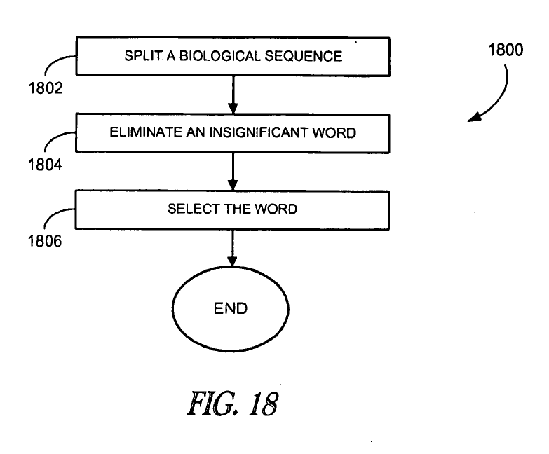

FIG. 18 illustrates a method 1800 for word extraction according to an example embodiment. The method 1800 may be performed at block 1006, block 1108, block 1210, or otherwise performed.

The biological sequence is split into available words using the spacer at block 1802. For example, characters of the biological sequence may be replaced with blank space characters or nonoccurring characters in the sequence and the grouping of one or more characters may be the available words.

One or more insignificant words may be eliminated from the available words at block 1804. For example, only large words may be retained.

The word may be selected from the available words at block 1806. The selection of the word may be based on the elimination of the insignificant word, a length of the word, or may be otherwise based. For example, a frequency of a particular word in the target sequence database 108 may be determined by statistical methods or experience to be insignificant (e.g., the word ‘CGTAG’ may be less frequent than ‘AAAAA’).

In an example embodiment, the methods 400, 500, 900, 1000, 1100; 1200, 1800 may be implemented in a computer programming language and/or in a particular computer environment. For example, the computer programming language may be C, C++, or JAVA. The computer environment may be provided by SAP. However, other programming languages and environments may also be used.

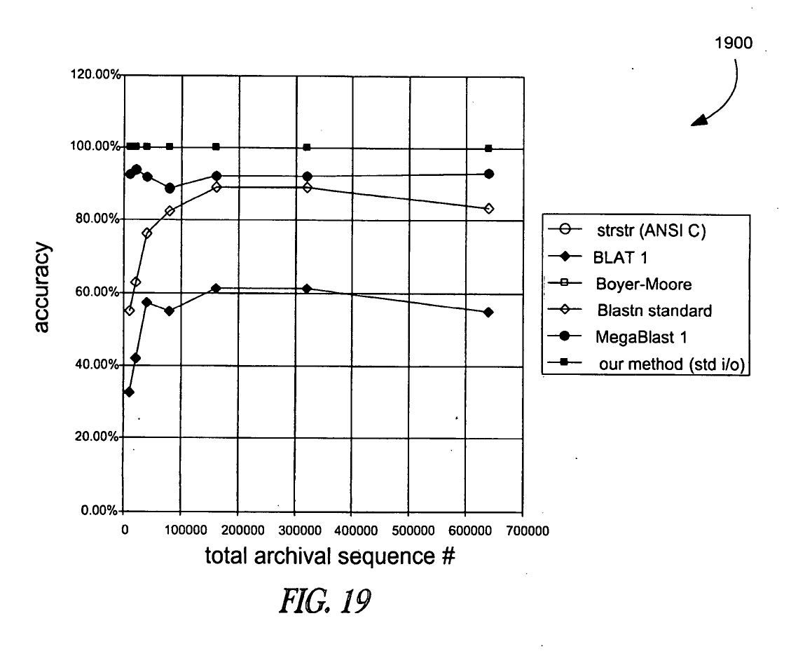

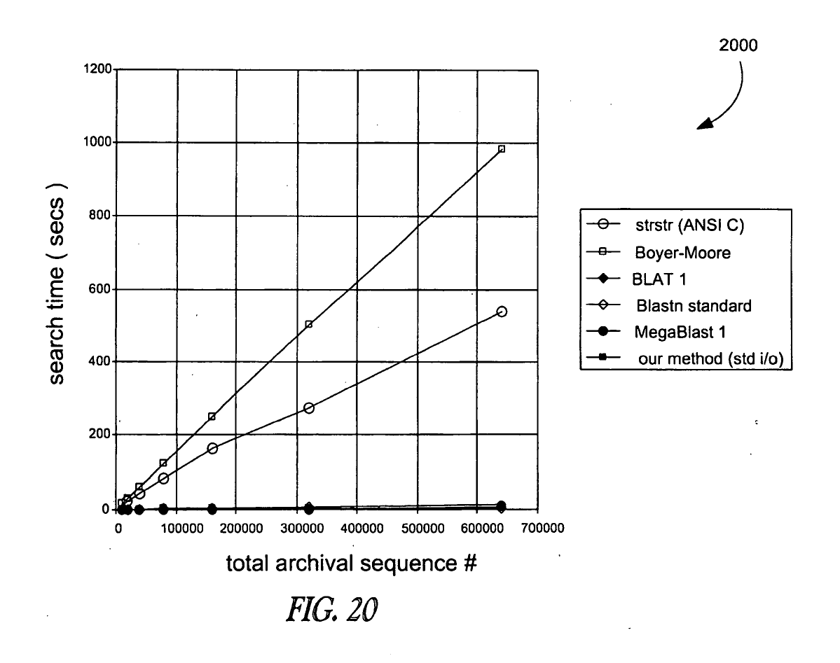

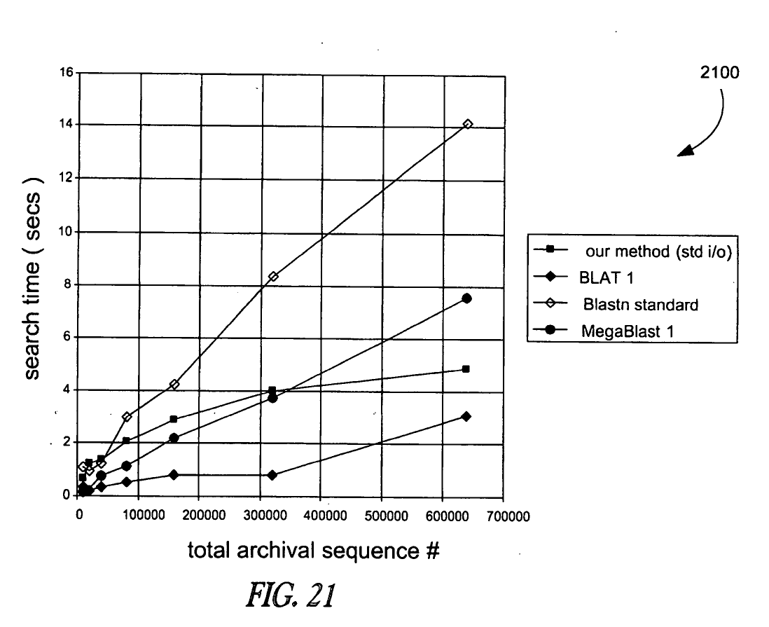

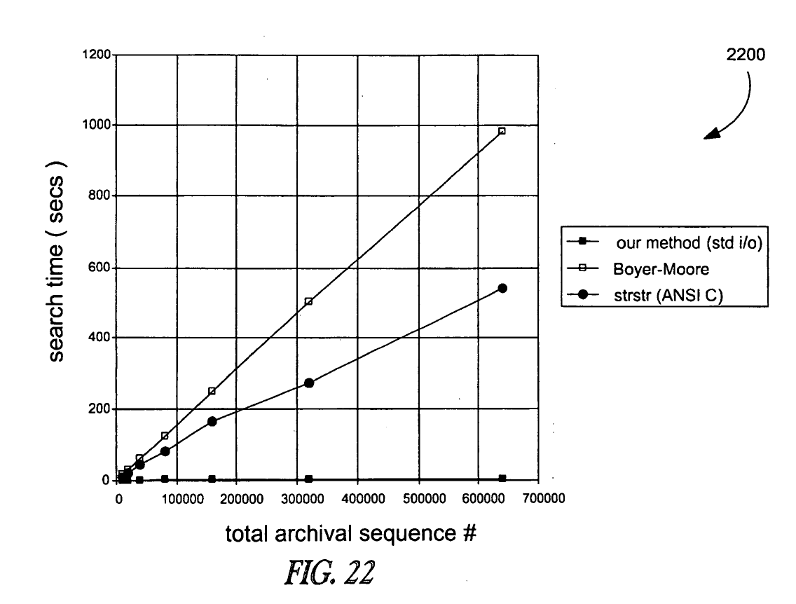

FIGS. 19-22 illustrate example benchmark diagrams 1900, 2000, 2100, 2200 of the method 400 according to an example embodiment. The benchmark diagrams 1900, 2000, 2100, 2200 may reflect a raw implementation of the method 400 in the C programming language for preliminary benchmark purposes. The benchmarking may be a result preliminary implementation of the method 400 and a different result may be achieved with a final implementation.

The target sequence database 108 used for the benchmarks is the Unigene Xenopus laevis build #81. The probes used for the benchmarks are Oligo probes. 25 bp oligonucleotides were randomly chosen from sequences in Unigene Xenopus laevis build #81. The search type used for the benchmarks is a perfect match search. The accuracy is defined as a percentage of concordant results in respect of results obtained using the ANSI C standard function (strstr).

The compiler used for the benchmarks was a gcc version 4.0.1 (Apple Inc. build 5465). The computer system on which the benchmarks was conducted was a MACBOOK 3.1, INTEL CORE 2 DUO, 2 GHz, 1 GB RAM and 800 MHz bus.

The benchmark 1900 illustrates accuracy versus database size for strstr (ANSI C), Boyer-Moore, MegaBlast 1, Blastn standard, BLAT 1 and the method 400. The data for the method 400, strstr, and ‘Boyer-Moore’ data series overlap in the diagram 1900.

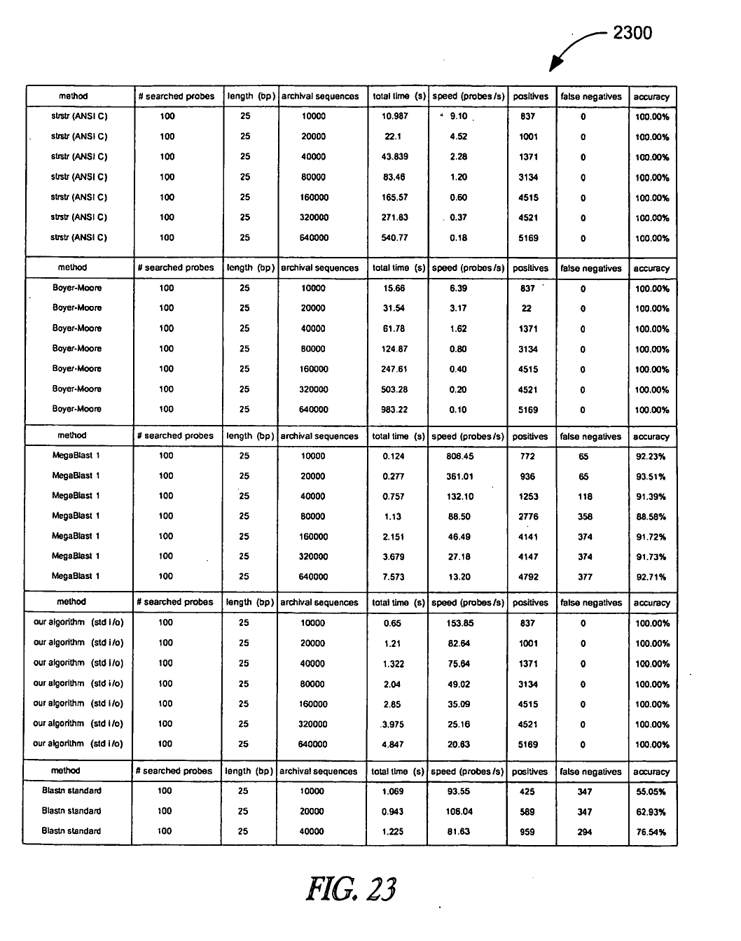

The diagrams 2000, 2100, 2200 illustrate search time versus database size. The diagram 2000 includes strstr (ANSI C), Boyer-Moore, MegaBlast 1, Blastn standard, BLAT 1 and the method described herein such as method 400. The database used for the present testing can be found at http://www.ncbi.nlm.nih.gov/UniGenefUGOrg.cgi?TAXID=8355 at the time of the filing this application. The data for the method 400, ‘BLAT1’, ‘Blastn standard’ and ‘MegaBlast 1’ data series overlap in the diagram 2000. The benchmark 2100 excludes the strstr (ANSI C) and Boyer-Moore. The benchmark 2200 includes strstr (ANSI C) and Boyer-Moore with the method 400. A table of the test data, as preliminary benchmark data, is reproduced in FIG. 23 as table 2300, which shows that the present method was clearly the fastest method with 100% accuracy and no false positives.

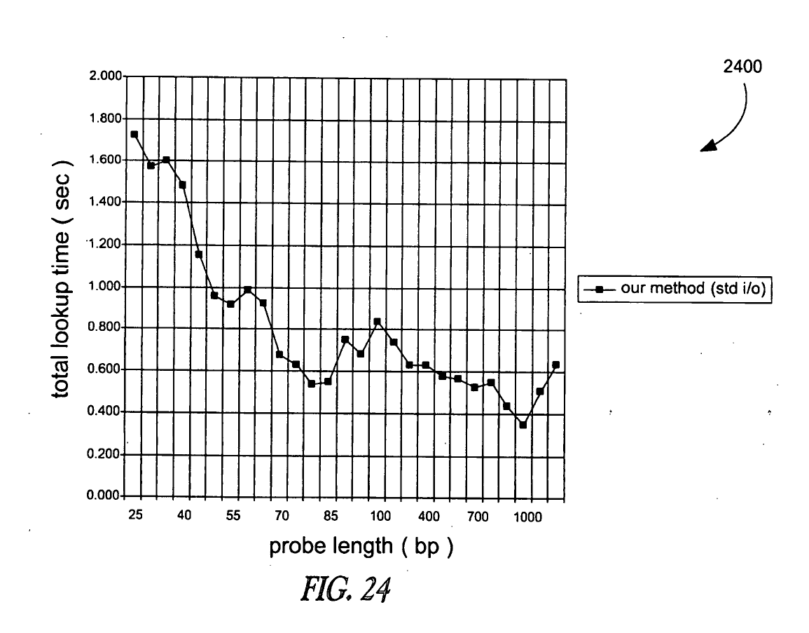

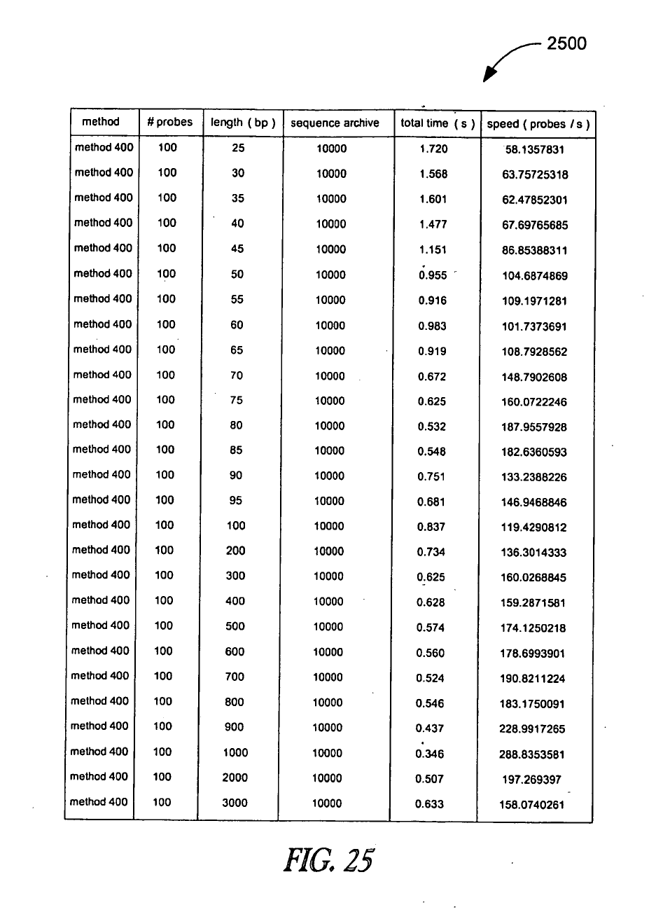

FIG. 24 illustrates an example diagram 2400 of the method 400 according to an example embodiment. The diagram 2400 shows look up time versus probe length using methods and apparatus described herein. The target sequence database 108 used is the Unigene Xenopus laevis build #81. The probes used are 25 bp to 3000 bp random sequences from Unigene Xenopus laevis build #81. The search type used is a perfect match search as described herein. A table of the test data is reproduced in FIG. 25 as table 2500. The diagram may be a result preliminary implementation of the method 400 and a different result may be achieved with a final implementation.

The compiler used in generating the diagram 2400 was a gcc version 4.0.1 (Apple Inc. build 5465). The computer system on which the diagram was generated was a MACBOOK 3.1, INTEL CORE 2 DUO, 2 GHz, 1 GB RAM and 800 MHz bus.

The methods 400, 500, 900, 1000, 1100, 1200, 1800 may improve one or more of the following:

Memory usage—as there is no need of completely loading the index into the RAM like BLAT and SSAHA do. This drastically reduces the amount of RAM needed during the searches.

Improve speed—as the actual search is made onto a relatively small subset of candidate sequences, the resulting search speed is dramatically increased (100-fold faster than the Boyer-Moore algorithm in preliminary lab tests)

Sensitivity—results are exact (100% concordance with the Boyer-Moore algorithm in perfect match searches).

Scalability—target database indexing may be performed in job blocks, dependent on available memory. As the original database evolves, newly introduced sequences can be indexed and added without the need to rebuild the whole indexes.

As opposed to current methods that breakdown biological sequences into discrete fragments of a defined length (k-mers), the present methods and systems use naturally occurring words in the biological sequence themselves to define variable length words by using at least one of the components of the biological sequence as a spacer that delimits the natural words. Each component of the biological sequence defines different natural words, which in turn are indexed in separate indexes. These separate indexes can be searched and then results intersected to achieve greater search speed and accuracy.

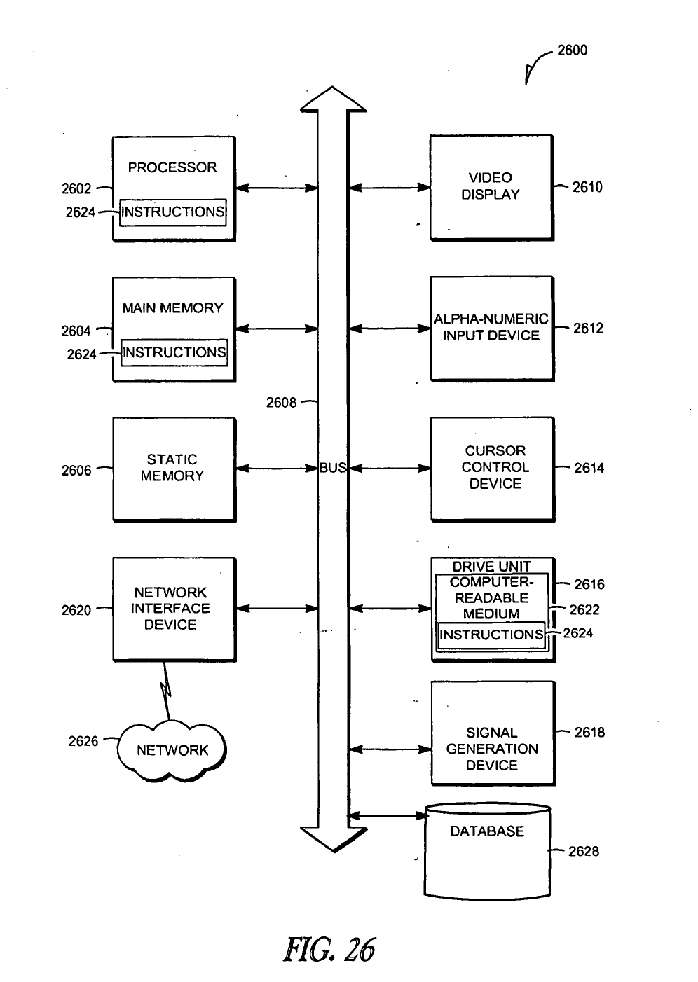

FIG. 26 shows a diagrammatic representation of machine in the example form of a computer system 2600 within which a set of instructions may be executed causing the machine to perform any one or more of the methods, processes, operations, or methodologies discussed herein. The provider 106 may operate on one or more computer systems 2600. The client machine 102 may include the functionality of the one or more computer systems 2600.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch of bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2600 includes a processor 2602 (e.g., a central processing unit (CPU) a graphics processing unit (GPU) or both), a main memory 2604 and a static memory 2606, which communicate with each other via a bus 2608. The computer system 2600 may further include a video display unit 2610 (e.g., a liquid crystal display (LCD) or a cathode ray tube (CRT)). The computer system 2600 also includes an alphanumeric input device 2612 (e.g., a keyboard), a cursor control device 2614 (e.g., a mouse), a drive unit 2616, a signal generation device 2618 (e.g., a speaker) and a network interface device 2620.

The drive unit 2616 includes a machine-readable medium 2622 on which is stored one or more sets of instructions (e.g., software 2624) embodying any one or more of the methodologies or functions described herein. The software 2624 may also reside, completely or at least partially, within the main memory 2604 and/or within the processor 2602 during execution thereof by the computer system 2600, the main memory 2604 and the processor 2602 also constituting machine-readable media.

The software 2624 may further be transmitted or received over a network 2626 via the network interface device 2620.

While the machine-readable medium 2622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

The example computer system 2600 may include a database 2628 for retaining data.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for query searching of a biological database have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

The Abstract of the Disclosure is provided to comply with 37 C.F.R. §1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving a query for a source sequence;
accessing one or more probe words of the source sequence;
identifying a plurality of candidate sequences using one or more sequence indexes and the probe word;
accessing the plurality of candidate sequences from a target sequence database;
performing an operation on the plurality of candidate sequences using the query; and
providing an output based on the performing of the operation.

2. The method of claim 1, further comprising:
selecting the sequence index from a plurality of available sequence indexes based on the probe word.

3. The method of claim 1, wherein the accessing of the probe word comprises:
splitting the source sequence into a plurality of available probe words using a spacer, the spacer being a particular character within the source sequence; and
selecting the probe word from the plurality of available probe words.

4. The method of claim 3, wherein the selecting of the probe word comprises:
selecting the probe word from the plurality of available probe words based on a length of the probe word.

5. The method of claim 3, further comprising:
ignoring an initial available probe word and a final available probe word of the plurality of available probe words,
wherein the selecting of the probe word from the plurality of available probe words is based on the ignoring.

6. The method of claim 1, wherein the performing of the operation comprises:
identifying one or more sequences of the plurality of candidate sequences that includes the probe word.

7. The method of claim 6, wherein the identifying of the particular sequence comprises:
identifying the one or more sequences of the plurality of candidate sequences that includes the probe word and one or more additional probe words of the source sequence.

8. The method of claim 1, further comprising:
determining a total character number of the probe word,
wherein the performing of the operation is based on the total character number.

9. The method of claim 1, wherein the accessing of the plurality of candidate sequences comprises:
accessing the plurality of candidate sequences from a target sequence database based on a list of identifiers,
wherein the identifying a plurality of candidate sequences includes obtaining a list of identifiers for the plurality of candidate sequences.

10. The method of claim 1, further comprising:
interrogating an additional sequence index using the query to identify a plurality of additional candidate sequences;
intersecting the plurality of candidate sequences and the plurality of additional candidate sequences to identify a plurality of intersected candidate sequences,
wherein the accessing of the plurality of candidate sequences comprises accessing the plurality of intersected candidate sequences.

11. The method of claim 1, further comprising:
sequence indexing a target sequence database using one or more spacers to create the sequence index.

12. The method of claim 1, wherein the performing of the operation comprises:
identifying one or more candidate sequences among the plurality of sequences using the query,
wherein the output includes the particular candidate sequence.

13. The method of claim 1, wherein the operation is a search or a comparison.

14. A method comprising:
extracting one or more words from a biological sequence using one or more spacers, the spacer being a particular character within the biological sequence; and
storing the word and a position of the word within the biological sequence in a sequence index associated with the spacer, the sequence index capable of being used for an operation associated with the biological sequence.

15. The method of claim 14, further comprising:
storing an identifier for the biological sequence in the sequence index.

16. The method of claim 14, wherein the extracting of the word comprises:
splitting the biological sequence into a plurality of available words using the spacer; and
selecting the word from the plurality of available words.

17. The method of claim 16, further comprising:
eliminating one or more insignificant words from the plurality of available words,
wherein the selecting of the word is based on the eliminating of the insignificant word.

18. The method of claim 16, wherein the selecting of the word comprises:
selecting the word from the plurality of available words based on a length of the word.

19. The method of claim 14, further comprising:
extracting one or more additional words from the biological sequence using one or more additional spacers, the additional spacer being a different character within the biological sequence than the particular character; and
storing the additional word and the position of the additional word within the biological sequence in one or more additional sequence indexes associated with the additional spacer.

20. The method of claim 19, further comprising:
using a result of a reading of the sequence index and the additional sequence index to create an intersected sequence index.

21. The method of claim 19, wherein a length of the word is not the same as the length of the additional word.

22. The method of claim 14, further comprising:
accesssing the biological sequence from a target sequence database,
wherein the extracting of the word is based on the accessing of the biological sequence.

23. The method of claim 14, further comprising:
receiving a deletion notification of a deletion of the biological sequence from a target sequence database; and
deleting the position of the word within the biological sequence based on the receiving of the deletion notification.

24. The method of claim 14, further comprising:
receiving an addition notification of an addition of the biological sequence,
wherein the extracting of the word from the biological sequence using the spacer is based on the receiving of the addition notification.

25. The method of claim 14, further comprising:
receiving a modification notification of a prior biological sequence;
deleting a prior position of a prior word within the prior biological sequence based on the receiving of the modification notification,
wherein the extracting of the word from the biological sequence using the spacer is based on the receiving of the modification notification.

26. The method of claim 14, further comprising:
converting the word into an integer,
wherein the storing of the word comprises storing the integer and a position of the word within the biological sequence in the sequence index associated with the spacer.

27. The method of claim 14, further comprising:
selecting the spacer from a spacer set.

28. The method of claim 27, wherein the spacer set is A, C, G, and T or G, P, A, V, L, I, M, C, F, Y, W, H, K, R, Q, N, E, D, S, and T.

29. A machine-readable medium comprising instructions, which when implemented by one or more processors perform the following operations:
receive a query for a source sequence;
access one or more probe words of the source sequence;
identify a plurality of candidate sequences using one or more sequence indexes and the probe word;
access the plurality of candidate sequences from a target sequence database;
perform an operation on the plurality of candidate sequences using the query; and
provide an output based on performance of the operation.

30. The machine-readable medium of claim 29, wherein the one or more instructions to access the probe word include:
split the source sequence into a plurality of available probe words using a spacer, the spacer being a particular character within the source sequence; and
select the probe word from the plurality of available probe words.

31. A machine-readable medium comprising instructions, which when implemented by one or more processors perform the following operations:
extract a word from a biological sequence using a spacer, the spacer being one or more characters within the biological sequence; and
store the word and a position of the word within the biological sequence in a sequence index associated with the spacer, the sequence index capable of being used for operation associated with the biological sequence.

32. The machine-readable medium of claim 31, wherein the one or more instructions to extract the word include:
splitting the biological sequence into a plurality of available words using the spacer; and
selecting the word from the plurality of available words.

33. A system comprising:
a query receiver module to receive a query for a source sequence;
a probe word access module to accessing one or more probe words of the source sequence;
a sequence identification module to identify a plurality of candidate sequences using one or more sequence indexes and the probe word accessed by the probe word access module;
a sequence access module to access the plurality of candidate sequences identified by the sequence identification module from a target sequence database;
an operation performance module to perform an operation on the plurality of candidate sequences accessed by the sequence access module using the query; and
an output provider module to provide an output based on the performing of the operation by the operation performance module.

34. The system of claim 33, further comprising:
a word extraction Module to extract a word from a biological sequence using a spacer, the spacer being a particular character within the biological sequence; and
a storage module to store the word and a position of the word within the biological sequence in a sequence index associated with the spacer,
wherein the sequence index is capable of being used by the sequence identification module to identify the candidate sequences.


SEQUENCE LISTING (52 sequences)

SEQ ID NO: 1 - DNA, 11 bp, Homo sapiens
agtgcacgcat

SEQ ID NO: 2 - DNA, 37 bp, Homo sapiens
agatatcttggctcgtcgtaccaactccagtttcaac

SEQ ID NO: 3 - DNA, 37 bp, Homo sapiens
tgattcctggttgtgaagtgcacgcattagatctcag

SEQ ID NO: 4 - DNA, 37 bp, Homo sapiens
cgagcagcagtagatctcaggggagtcttgcaacaat

SEQ ID NO: 5 - DNA, 37 bp, Homo sapiens
agtccggaagtgcacgcattgagaagcagtagatctc

SEQ ID NO: 6 - DNA, 37 bp, Homo sapiens
tcccggggagaacagtagatctcaggggagtcttgca

SEQ ID NO: 7 - DNA, 13 bp, Homo sapiens
cttggctcgtcgt

SEQ ID NO: 8 - DNA, 14 bp, Homo sapiens
agcagaagcacagc

SEQ ID NO: 9 - DNA, 18 bp, Homo sapiens
gctgtcgggctgggcgct

SEQ ID NO: 10 - DNA, 36 bp, Homo sapiens
gcgataggactgtcgggtcgctgggcgctctaggaa

SEQ ID NO: 11 - DNA, 18 bp, Homo sapiens
gctgtcgggctgggcgct

SEQ ID NO: 12 - DNA, 36 bp, Homo sapiens; identical to SEQ ID NO: 10

SEQ ID NO: 13 - DNA, 18 bp, Homo sapiens
actagcagaagcacagct

SEQ ID NO: 14 - DNA, 18 bp, Homo sapiens
actagcagaagcacagct

SEQ ID NO: 15 - DNA, 18 bp, Homo sapiens
actagcagaagcacagct

SEQ ID NO: 16 - DNA, 18 bp, Homo sapiens
actagcagaagcacagct

SEQ ID NO: 17 - DNA, 14 bp, Homo sapiens
agcagaagcacagc

SEQ ID NO: 18 - DNA, 37 bp, Homo sapiens; identical to SEQ ID NO: 6

SEQ ID NO: 19 - DNA, 37 bp, Homo sapiens; identical to SEQ ID NO: 2

SEQ ID NO: 20 - DNA, 14 bp, Homo sapiens
tcttggctcgtcgt

SEQ ID NO: 21 - DNA, 12 bp, Homo sapiens
ttcctggttgtg

SEQ ID NO: 22 - DNA, 13 bp, Homo sapiens
cttggctcgtcgt

SEQ ID NO: 23 - DNA, 37 bp, Homo sapiens; identical to SEQ ID NO: 2

SEQ ID NO: 24 - DNA, 37 bp, Homo sapiens; identical to SEQ ID NO: 2

SEQ ID NO: 25 - DNA, 28 bp, Homo sapiens
gttcttggctcgtcgtccctccgtttcc

SEQ ID NO: 26 - DNA, 28 bp, Homo sapiens
gttcttggctcgtcgtccctccgtttcc

SEQ ID NO: 27 - DNA, 23 bp, Homo sapiens
tcttggctcgtcgtctccgtttc

SEQ ID NO: 28 - DNA, 14 bp, Homo sapiens
tcttggctcgtcgt

SEQ ID NO: 29 - DNA, 31 bp, Homo sapiens
agatatcttggctccaccaactccattcaac

SEQ ID NO: 30 - DNA, 30 bp, Homo sapiens
agatatcttggctcaccaactccattcaac

SEQ ID NO: 31 - DNA, 10 bp, Homo sapiens
accaactcca

SEQ ID NO: 32 - DNA, 14 bp, Homo sapiens
agatatcttggctc

SEQ ID NO: 33 - DNA, 37 bp, Homo sapiens; identical to SEQ ID NO: 2

SEQ ID NO: 34 - DNA, 31 bp, Homo sapiens
agacttggctcgtcgtaccaactccagttac

SEQ ID NO: 35 - DNA, 31 bp, Homo sapiens; identical to SEQ ID NO: 34

SEQ ID NO: 36 - DNA, 26 bp, Homo sapiens
cttggctcgtcgtaccaactccagtt

SEQ ID NO: 37 - DNA, 26 bp, Homo sapiens
cttggctcgtcgtaccaactccagtt

SEQ ID NO: 38 - DNA, 11 bp, Homo sapiens
agtgcacgcat

SEQ ID NO: 39 - DNA, 12 bp, Homo sapiens
ttcctggttgtg

SEQ ID NO: 40 - DNA, 13 bp, Homo sapiens
cttggctcgtcgt

SEQ ID NO: 41 - DNA, 14 bp, Homo sapiens
agcagaagcacagc

SEQ ID NO: 42 - DNA, 22 bp, Homo sapiens
gctagtcgagagctgggcagct

SEQ ID NO: 43 - DNA, 44 bp, Homo sapiens
gcgataggactagtcgaggaatcaaagctgggcagctctaggaa

SEQ ID NO: 44 - DNA, 18 bp, Homo sapiens
gctgtcgggctgggcgct

SEQ ID NO: 45 - DNA, 36 bp, Homo sapiens; identical to SEQ ID NO: 10

SEQ ID NO: 46 - DNA, 21 bp, Homo sapiens
cgtgactcgtgcggcattccg

SEQ ID NO: 47 - DNA, 19 bp, Homo sapiens
cgtgctcgtgcggcttccg

SEQ ID NO: 48 - DNA, 11 bp, Homo sapiens
agaaaggccgc

SEQ ID NO: 49 - DNA, 18 bp, Homo sapiens
actagcagaagcacagct

SEQ ID NO: 50 - DNA, 14 bp, Homo sapiens
agcagaagcacagc

SEQ ID NO: 51 - DNA, 37 bp, Homo sapiens; identical to SEQ ID NO: 2

SEQ ID NO: 52 - DNA, 37 bp, Homo sapiens; identical to SEQ ID NO: 2